(19) United States
(12) Patent Application Publication
(10) Pub. No.: US 2018/0242404 A1
(43) Pub. Date: Aug. 23, 2018

(54) LENS HOOD FOR WINDSHIELD CAMERA

(71) Applicant: K.L. Kaschier-und Laminier GmbH, Bad Bentheim-Gildehaus (DE)

(72) Inventors: Rembert Schulze WEHNINCK, Tutzing (DE); Thomas Ewald GROSSPIETSCH, Ochtrup (DE)

(21) Appl. No.: 15/897,264

(22) Filed: Feb. 15, 2018

(30) Foreign Application Priority Data
Feb. 17, 2017 (DE) 102017001513.9

(51) Int. Cl. H05B 3/84; B60R 11/04; G03B 11/04; G03B 17/55; H05B 3/14; G02B 27/00

(52) U.S. Cl. CPC H05B 3/84; B60R 11/04; G03B 11/045; B60R 2011/0026; H05B 3/14; G02B 27/0006; G03B 17/55

(57) ABSTRACT

In a lens hood for a camera on an inner face of a motor vehicle glass and having a floor in which a flat heating element is embedded. Opposite faces of the heating element are parallel with an upper and/or lower face of the floor, and the lens hood is made by plastic injection molding. Both an upper and a lower face of the flat heating element embedded in the floor are covered by respective upper and lower layers of the plastic, and a spacer holds the flat heating element in a centered position between the upper and lower faces of the floor.

### FIELD OF THE INVENTION

The present invention relates to a lens hood. More particularly this invention concerns such a lens hood used for a camera mounted behind windshield or the like, e.g. the transparent cover of a auto-body camera.

### BACKGROUND OF THE INVENTION

The invention relates to a lens hood of a camera that is mounted on the inner face of a motor-vehicle glass, a flat heating element being provided in the floor of the lens hood, the faces of the heating element being parallel with the upper and/or lower surfaces of the floor.

In the case of cameras in motor vehicles, fault free functioning has to be guaranteed in the case of poor environmental conditions. Deposits of mist and ice on the outside of the glass through which the camera is aimed are particularly problematic. A heater for removing ice and condensation is therefore important. The de-icing process is effected by radiantly heating the glass where the lens hood is mounted. The lens hood in the case of most de-icing systems is heated from the rear side. It is problematic herein that a lot of material has to be heated, this increasing the reaction time of the heater.

### OBJECTS OF THE INVENTION

It is therefore an object of the present invention to provide an improved lens hood for an auto camera.

Another object is the provision of such an improved lens hood for an auto camera that overcomes the above-given disadvantages, in particular where the heater of the lens hood keeps the windshield or glass free of fogging by ice and condensation in a highly efficient manner in the region of the camera.

### SUMMARY OF THE INVENTION

In a lens hood for a camera on an inner face of a motor vehicle glass and having a floor in which a flat heating element is embedded. Opposite faces of the heating element are parallel with an upper and/or lower face of the floor, and the lens hood is made by plastic injection molding. Both an upper and a lower face of the flat heating element embedded in the floor are covered by respective upper and lower layers of the plastic, and a spacer holds the flat heating element in a centered position between the upper and lower faces of the floor.

Such a solution has inter alia the following advantages:
the glass is reliably kept free of ice and fogging by way of a simple manufacture and a low investment of energy;
the heated film is protected against harmful environmental influences such as, for example, intense solar radiation in summer;
fixing the lens hood heater in a composite material enables the heating to be operated at higher average temperatures; and
the manufacture of the lens hood is performed conjointly with that of the heating element in one single operating step of injection molding.

The manufacture of the heated floor of the lens hood is particularly simple when the spacer/spacers is/are formed by a textile. This is ensured when the textile/textiles is/are permeable to molten plastic. The textile should also have intermediate spaces which are permeable to molten plastic. The textile herein can be a mesh.

It is preferably proposed that two or more in particular textile-type spacers are mounted, intermediate spaces through which the liquid plastic passes being formed between the spacers. It is furthermore proposed that the flat heating element is formed by a heated film which has an electrically conducting coating and/or conducting tracks.

### BRIEF DESCRIPTION OF THE DRAWING

The above and other objects, features, and advantages will become more readily apparent from the following description, reference being made to the accompanying drawing in which:

FIG. 1 is a largely schematic view of an auto camera with a lens hood according to the invention;

FIG. 2 is a section taken along line II-II through the floor of the lens hood of FIG. 1.

### SPECIFIC DESCRIPTION OF THE INVENTION

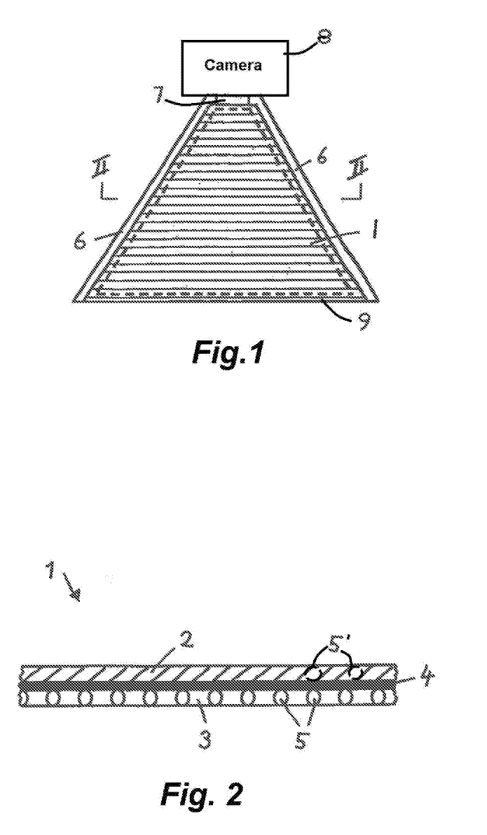

As seen in FIG. 1 a camera 8 is fastened to the internal face of a motor vehicle glass 9, in particular of a windshield, a lens hood having a generally horizontal floor 1 and generally vertical side walls 2 is provided in front of and below the a lens opening 7 of the camera 8. The glass can be a front or rear windshield or the lens of a body-mounted camera forming part of a self-driving or lane-holding system.

The floor 1 of the lens hood is as shown in FIG. 2 composed of at least three layers, that is to say an upper plastic layer 2, one lower plastic layer 3, and one layer of a flat heating element 4 that is provided between the two layers and generates heat. The two plastic layers 2 and 3 are composed of a polymer plastic.

The lens hood and its floor 1 are produced by plastic injection molding in one operational step, and the flat heating element 4 is placed into the mold prior to the plastic being injected thereinto. Moreover, at least one spacer 5 that ensures that the injected plastic makes its way to both sides of the heating element such that the heating element 4 is centered between the two plastic layers 2 and 3 when placed into the mold on one side of the flat heating element 4.

The spacer 5 in the illustrated embodiment is embedded in the lower plastic layer 3. However, the spacer can instead also be embedded in the upper plastic layer 2 or in both layers 2 and 3.

A textile (woven fabric, warp or weft knitted fabric, felt, or non-woven) preferably forms the spacer 5, and the filaments or fibers of the textile are embedded such that the injected plastic can get between the fibers, for example by virtue of a mesh shape. Alternatively or additionally, the textile can be embedded only in places, in particular in a punctiform manner, such that the textile forms intermediate spaces through which the injected plastic can penetrate.

As shown in broken lines in FIG. 2, it is also possible to provide a spacer mesh 5′ in the upper layer 2.

The flat heating element can be constructed in various manners. It is preferably formed by a heater film having an electrically conducting coating and/or conducting tracks.

We claim:

1. In a lens hood for a camera on an inner face of a motor vehicle glass and having a floor in which a flat heating element is embedded, the improvement wherein:
opposite faces of the heating element are parallel with an upper and/or lower face of the floor,
the lens hood is made by plastic injection molding;
both an upper and a lower face of the flat heating element embedded in the floor are covered by respective upper and lower layers of the plastic; and
a spacer holds the flat heating element in a centered position between the upper and lower faces of the floor.

2. The improvement defined in claim 1, wherein the spacer is formed by a textile.

3. The improvement defined in claim 2, wherein the textile is permeable to the liquefied plastic from which the upper and lower layers are injection-molded.

4. The improvement defined in claim 2, wherein the textile has intermediate spaces permeable to the liquefied plastic from which the layers are injection molded.

5. The improvement defined in claim 4, wherein the textile is a mesh embedded in one of the layers..

6. The improvement defined in claim 1, further comprising another mesh in the other layer.

7. The improvement defined in claim 1, wherein the flat heating element is formed by a heated film which has an electrically conducting coating and/or conducting tracks.
